(19) United States
(12) Patent Application Publication
(10) Pub. No.: US 2011/0132788 A1
(43) Pub. Date: Jun. 9, 2011

(54) Films and Methods for Making Tampering Events Evident

(75) Inventors: Jeffrey Alan Middlesworth, Wauconda, IL (US); Brooke Kitzmiller, North Canton, OH (US); William J. Barlow, Jackson, TN (US)

(73) Assignee: PLIANT,LLC., Evansville, IN (US)

(21) Appl. No.: 12/921,605

(22) PCT Filed: Apr. 6, 2009
(86) PCT No.: PCT/US2009/039638

§ 371 Date: Feb. 14, 2011

Related U.S. Application Data
(60) Provisional application No. 61/042,499, filed on Apr. 4, 2008.

(51) Int. Cl. B65D 90/00; G08B 13/00; B65D 65/40; B65D 65/42; B32B 37/00; G01N 21/64

(52) U.S. Cl. 206/459.5; 428/195.1; 428/411.1; 428/43; 156/306.3; 250/459.1

(57) ABSTRACT

Films and methods for making tampering events obvious are disclosed. In one embodiment, a tamper evident film includes a coating containing a first substance, and an observable change occurs when the first substance comes into contact with a second substance. In another embodiment, a tamper evident stretch wrap includes an inner portion, an outer portion, and a substance between the inner and outer portions that is adapted to escape from between the portions when the outer portion is breached. In another embodiment, a tamper evident stretch wrap includes a first layer of film having a first pattern and a second layer of film having a second pattern that overlap to form a predetermined third pattern. In yet another embodiment, a stretch wrap is exposed to ultraviolet light and checked for a change in a fluorescent signature to determine whether the stretch wrap has been breached.

### RELATED APPLICATIONS

This patent application makes reference to, claims priority to and claims benefit from U.S. Provisional Patent Application Ser. No. 61/042,499, filed on Apr. 4, 2008.

### FEDERALLY SPONSORED RESEARCH OR DEVELOPMENT

This research was sponsored in connection with D-U-N-S No. 03-747-3857, Contract Nos. W911QY-06-C-0072 and W911QY-05-C0093.

### MICROFICHE/COPYRIGHT REFERENCE

[Not Applicable]

### BACKGROUND OF THE PRESENT TECHNOLOGY

The present technology generally relates to wrapping film that can be used to wrap a load, such as a stack of articles on a pallet. More specifically, the present technology relates to films and methods for making tampering with a wrap obvious.

In the stretch wrapping process, a film is typically stretched while being applied around a revolving load. The wrapping process commonly includes spiraling the film up and down the load to apply two or more layers of film over any given area. Alternatively, in the shrink wrapping process, one or more layers of film are shrunk in place around a load, typically by using heat. Wrap film is generally intended to be easily removed by the end user, and this attribute results in a risk that the wrap can be easily breached and the contents of the load damaged, stolen or tampered with. A breach of the wrap may not be easily detectable. For example, small penetrations of the wrap may not be readily visible. Furthermore, a portion of the wrap may be removed or peeled back, and any subsequent replacement of the film may not be easily detectable, especially in a warehouse environment.

The wrapping film can be any polymer film, including polyethylene, polyvinyl chloride, and polyolefin films. Features have been added to the wrapping film and other packaging to make tampering events more obvious. For example, some films have been printed with a personalized logo to prevent rewrapping of the load with a different film.

Claim 1 of U.S. Pat. No. 4,516,679 discloses a “tamper-proof wrap . . . comprising interior and exterior sheets of a thin plastic material position over one another and bonded together around the outer edge and including a layer of a select chemical sealed therebetween such that on puncture of the wrap exterior sheet, a chemical response will occur that will produce a visual indication at the wrap puncture . . . .”

Claim 1 of U.S. Pat. No. 5,104,704 discusses a “tamper evident wrap . . . comprising three overlapping layers of containment material” “two layers of two separate reactive materials separated by said layers of containment material bonded at their edges to completely encompass and isolate each layer of reactive material” “wherein said separate reactive materials are capable to undergoing a color change upon contact with one another.”

Claims 1 and 5 of U.S. Pat. No. 5,623,812 describe a wrap “consisting of a shrinkable, stretchable film first layer engaging and intermittently secured to a second layer of fibers arranged into a non-woven fabric” wrapped “with the second layer against the article and the first layer away from the article.” The '812 patent describes “applying an air activated color change chemical to said non-woven fabric whereby puncture of said first layer is indicated by color change of said second layer.”

Claim 1 of U.S. Pat. No. 4,511,052 discusses a sealing device for a container . . . comprising: a peelable band . . . , a hermetically sealed frangible envelope . . . and indicating means, for changing appearance in response to exposure to the ambient environment, contained within the sealed envelope whereby removal of said band ruptures the sealed envelope and exposes said indicating means to the ambient environment, the resultant change of appearance being visible form exterior of the container.

Claim 1 of U.S. Pat. No. 5,149,578 discloses a “multilayer optical interference film comprised of contiguous layers of two or more diverse thermoplastic materials of differing refractive indices whereby the film retains a permanent visual color change as evidence of tampering or an attempt at tampering when the yield point of at least one of the diverse materials has been at least equalled [sic] by the strain associated with such tampering or with such an attempt at tampering . . . .”

Claim 1 of U.S. Pat. No. 3,923,198 discusses a “[tape] closure surfaced with an indicator strip comprising a stress-opacifying colored backing whereby when said indicator layer is flexed to open said closure, said backing will become opaque and display a color difference between the flexed and unflexed portions indicating said flexing even if said covering is returned to its previous sealing position.”

Claim 1 of U.S. Pat. No. 3,896,965 describes a “container being sealed by a closure comprising a sheet of material” “on the outer surface of said closure an indicator layer comprising a strong, flexible binder matrix . . . containing, dispersed throughout, a solid color-forming substance and capsules containing a liquid dye precursor reactable with said color-forming substance” “whereby, when said closure is flexed by force applied to said free end, said capsules rupture and the color-forming substance and dye precursor react to form a colored dye indicating that said can closure has been at least partially removed.”

A “tag attachable to a package so as to produce a tamper evident packaging system” where the “tag includes a substantially oxygen impermeable upper barrier layer, a reactive intermediate layer, wherein the reactive intermediate layer includes a reactive material” that is “changeable between an un-reacted condition in the absence of oxygen and a reacted condition in the presence of oxygen wherein said change takes the form of a colour change” is discussed U.S. Publication No. 2004/0050740 A1.

In addition, U.S. Publication No. 2003/0127846 A1 describes “an anticounterfeit device” including “an oxygen-impermeable laminated article capable of attachment to the goods” having “a latent image formed on the substrate that becomes visible upon exposure to oxygen . . . .” All of the above-mentioned references are incorporated herein by reference in their entirety.

### BRIEF SUMMARY OF THE PRESENT TECHNOLOGY

One aspect of the present technology is a tamper evident single sheet of film having a first external coating containing a first substance and a second external coating containing a second substance. When the first substance comes into contact with a second substance, an observable change occurs.

Another aspect of the present technology is a tamper evident film having a coating containing a first substance. When the first substance is exposed to at least one second substance present in the vicinity of the film, an observable change occurs.

Another aspect of the present technology is a tamper evident wrap having an inner film portion and an outer film portion. The inner film portion has a first external coating containing a first substance and is wrapped about a load. The outer film portion has a second external coating containing a second substance and is wrapped about and at least partially overlapping the inner film portion. When the first substance comes into contact with the second substance, an observable change occurs.

Another aspect of the present technology is method of detecting tampering with a wrap that includes providing a stretch wrap having a fluorescent signature when exposed to ultraviolet light. This aspect of the method also includes exposing the stretch wrap to ultraviolet light and checking for a change in the fluorescent signature to determine whether the stretch wrap has been breached.

Another aspect of the present technology is a tamper evident wrap including an inner wrap portion and an outer film portion wrapped about a load and at least partially overlapping the inner film portion. The inner film portion has a surface facing away from the load. The outer film portion has a surface facing the inner film portion. The outer film portion at least partially overlaps the inner film portion. This aspect of the tamper evident wrap also includes a substance that is coated on at least one of the inner film portion surface or the outer film portion surface, is located between the first and second layers of film, and is adapted to escape from between the portions when the outer film portion has been breached.

Another aspect of the present technology is a tamper evident stretch wrap including a first layer of film and a second layer of film. The first layer has a first pattern, and the second layer has a second pattern. Further, the second layer at least partially overlaps the first layer so that the first pattern and the second pattern form a predetermined third pattern when the second layer is laid at a predetermined elongation and at a predetermined position relative to the first layer.

Another aspect of the present technology is a method of forming a tamper evident stretch wrap that includes laying a first layer of film having a first pattern over an article. This aspect of the method also includes laying, at a predetermined elongation and at a predetermined angle relative to the first layer, a second layer of film having a second pattern over the first layer. The first pattern and the second pattern form a predetermined third pattern.

Another aspect of the present technology is a method of detecting tampering with a stretch wrap that includes providing a stretch wrap having a first layer and a second layer. The first layer of film has a first pattern and a first predetermined elongation. The second layer of film has a second pattern and a second predetermined elongation and is positioned at a predetermined angle relative to the first layer. Furthermore, the first layer and second layer at least partially overlap so that the first pattern and the second pattern form a predetermined third pattern.

This aspect of the method also includes checking the stretch wrap for a change in the predetermined third pattern to determine whether the stretch wrap has been breached.

Another aspect of the present technology is a tamper evident film adapted to form tears in the machine direction when the film is breached.

### BRIEF DESCRIPTION OF SEVERAL VIEWS OF THE DRAWINGS

FIG. 1 is a perspective view of a film being wrapped around a load according to an embodiment.

FIG. 2 is a detail elevation view of FIG. 1.

FIG. 3 is a plan view of a film according to an embodiment having an external coating containing one substance and another external coating containing another substance.

FIG. 4 is a detail plan view of overlapping portions of the film of FIG. 3.

FIG. 5 is a section view taken along section line 5-5 of FIG. 4.

FIG. 6 is a detail elevation view of overlapping film portions having a coating having a substance that can undergo an observable change when it is exposed to at least one substance present in the vicinity of the film.

FIG. 7 is a perspective view of a stretch wrap having a fluorescent signature according to an embodiment.

FIG. 8 is a cross section view of overlapping portions of film according to an embodiment.

FIG. 9 is a detail elevation view of overlapping layers of film according to another embodiment.

FIG. 10 is a perspective view of a film, adapted to form tears (or splits) when breached, being wrapped around a load according to an embodiment.

FIG. 11 is a section view of an alternate embodiment similar to FIG. 5, where the overlapping layers of film are positioned such that the coatings are facing away from each other.

FIG. 12 is a section view of an alternate embodiment similar to FIG. 5, where the overlapping portions of film are positioned such that the external coatings are facing toward each other.

The following reference characters are used in the figures:

### REF. CHAR. STRUCTURE

1 film
2 load
3 article
5 pallet
7 inner portion
9 outer portion
11 overlap
13 first external coating
15 second external coating
17 one portion
19 another portion
21 separation
25 breach
26 nail
27 observable change
29 skin layer
35 second substance
37 breach
39 observable change
43 stretch wrap
45 fluorescent signature
47 ultraviolet light
49 breach
51 change
55 inner portion
57 outer portion
59 overlap
61 substance
63 breach
64 nail
75 first layer
77 second layer
79 first pattern
81 second pattern
83 angle
85 third pattern
87 breach
95 film
97 load
99 article
101 pallet
103 tears

The foregoing summary, as well as the following detailed description of certain embodiments of the present technology, will be better understood when read in conjunction with the appended drawings. For the purpose of illustrating the technology, certain embodiments are shown in the drawings. It should be understood, however, that the present technology is not limited to the arrangements and instrumentalities shown in the attached drawings or identified in this specification.

### DETAILED DESCRIPTION OF THE INVENTION

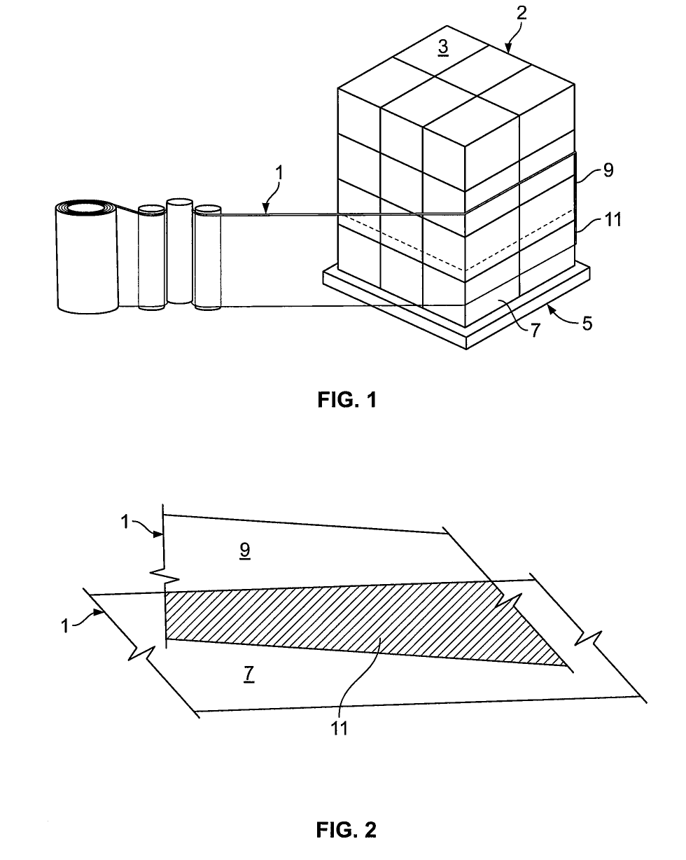

FIGS. 1 and 2 show a film 1 being wrapped around a load 2 of articles such as 3 stacked on a pallet 5 according to an embodiment. The film 1 can be a single-ply film or a multi-ply film. The film 1 can be spiraled up and down the load 2 to apply two or more layers, such as an inner portion 7 and an outer portion 9, creating an area of overlap 11 of the portions 7 and 9 over an area of the load 2. Portions 7 and 9 can be successive wraps of one continuous piece of film or layers of separate films.

FIG. 2 is a detail view of the embodiment of FIG. 1 showing the area of overlap 11 of the inner portion 7 and the outer portion 9 of the film 1.

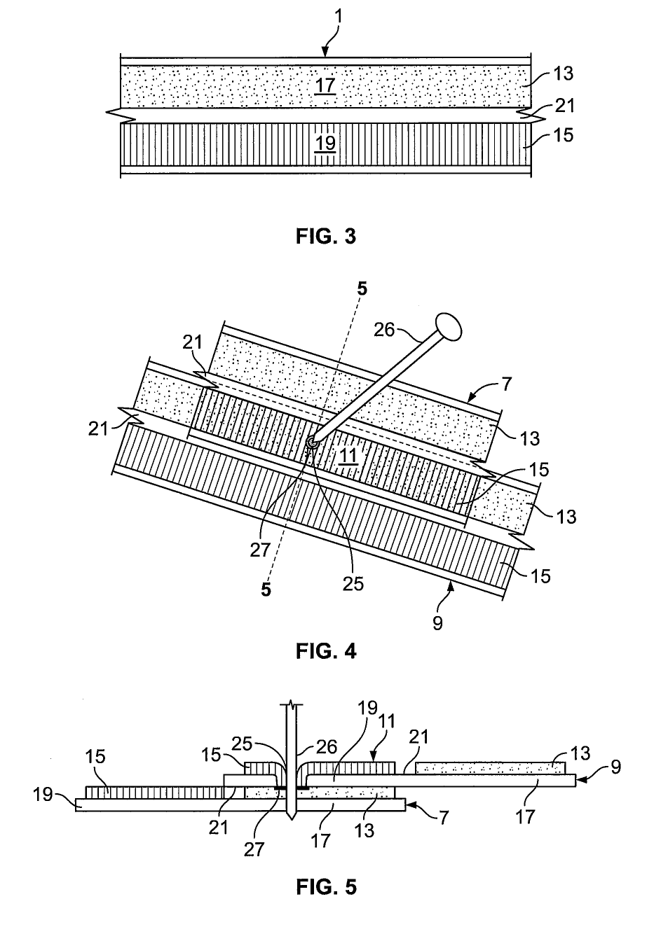

FIG. 3 is a detail view of the film 1 of the embodiment of FIG. 1. The film 1 can have a first external coating 13 containing a first substance and a second external coating 15 containing a second substance.

The first substance can be substantially on one portion 17 of the film 1 while the second substance can be substantially on another portion 19 of the film 1, thereby creating a separation 21 between the first external coating 13 and second external coating 15. In the illustrated embodiment, the two coatings 13 and 15 are side by side and run in the machine direction. The two coatings could also be a series of areas running in the cross-machine direction and alternating in the machine direction. Other arrangements are also contemplated.

FIGS. 4 and 5 show an overlap 11 created by film 1 of FIG. 3 when it is wound around a load 2. The first external coating 13 and the second external coating 15 can be on the same side, or face, of the film 1 so that, when the film 1 is spiraled up and down the load 2, the portion 17 of the film 1 having the first substance and the portion 19 of the film 1 having the second substance can create the area of overlap 11, where the film 1 is preventing contact between the first substance and the second substance. In this embodiment, when a breach 25 of the film 1 occurs, like, for example, by a puncture by an object (such as by a nail 26) or a tear, the first substance and the second substance can come into contact with one another, causing an observable change 27, such as a discolored region.

In an alternative embodiment, the coating 13 containing the first substance can be located on the inner portion 7 of the wrap and the second substance can be located on the outer portion 9 of the wrap, where the inner portion 7 and the outer portion 9 are made from one continuous sheet of film or two layers of separate films. The inner portion 7 and outer portion 9 can be positioned so that coatings 13 and 15 face away from each other (as illustrated in FIG. 11) or toward each other (as illustrated in FIG. 12). In certain embodiments, the coatings 13 and 15 are separated by at least one layer of film. This is illustrated in FIG. 5 where the coating 15 on one portion 19 of outer portion 9 and the coating 13 on one portion 17 of the inner portion 7 are separated by the outer portion 9 of the film. In other embodiments, coatings 13 and 15 are not separated by a layer of film (as illustrated in FIG. 12). In these embodiments, the first substance on the first coating 13 is not allowed to contact the second substance on the second coating 15 until there is a breach. This can be accomplished, for example, by formulating coatings 13 and/or 15 to have a high enough surface tension to create a skin layer 29 between the coatings 13 and 15 that will prevent substantial contact between the first and second substances until there is a breach 25, such as a puncture by a nail 26. In other embodiments, for example, varnish or wax fillers can be used to separate the coatings 13 and 15.

The first substance and the second substance can be any substances that produce an observable change when the substances come into contact with one another. The observable change can be, for example, a visual change, like a color change or a foaming effect, an olfactory change, or a temperature change. In one embodiment, the first substance can be an acid and the second substance can be a base, such that when the acid and base come into contact with one another, a color change or a foaming reaction occurs. In another embodiment, the first substance can be an acid or a base, and the second substance can include a pH indicator, such as, for example, methyl violet, thymol blue, bromocresol green, methyl red, and phenolphthalein, among others, which would result in a color change when the acid or base came into contact with the pH indicator. In yet another embodiment, the first substance can be yeast or other bacteria and the second substance could include nutrients that would lead to yeast growth, which would result in a discoloration and/or odor when the yeast and the nutrients come into contact.

Some specific examples of substances include, but are not limited to, the following: the first substance can be about 10-98% (w/v), preferably about 10-30% (w/v), sulfuric acid, and the second substance can be one or a mixture of several oxygenated organic compounds, such as sucrose and tartaric acid. When the sulfuric acid comes into contact with the oxygenated organic compound, a black carbon foam is produced. Alternatively, the first substance can be about 1-25% (w/v), preferably about 10-25% (w/v), potassium thiocyanate, and the second substance can be about 1 to 25% (w/v), preferably about 10-25% (w/v), ferric chloride, which will produce a red color upon contact. The first substance can be about 1-10%, preferably about 1-5% (w/v), ferric ammonium sulfate with the second substance being about 5-25% (w/v), preferably about 10-25% (w/v), of at least one of the following: potassium thiocyanate (deep red color); barium chloride (white cloudy precipitate); potassium ferrocyanide (deep blue color); tannic acid (black color); tartaric acid (greenish color); or hydrogen sulfite (amber color).

Other embodiments include the following: the first substance can be about 1-10% (w/v), and preferably about 1-5% (w/v), lead nitrate, and the second substance can be about 1-10% (w/v), and preferably about 1-5% (w/v), potassium iodide, which will result in a yellow color upon contact. The first substance can be about 1-25% (w/v), preferably 1-10% (w/v), ferric chloride solution, and the second substance can be about 1-25% (w/v), preferably about 10-25% (w/v), of at least one of the following: potassium thiocyanate (producing a red color on contact); potassium ferrocyanide (producing a blue color on contact); or tannic acid solution. The first substance can be dilute ammonium hydroxide with the second substance being about 0.5-5% (w/v), preferably about 0.5-1% (w/v), phenolphthalein in alcohol (producing a red color on contact); about 1-50% (w/v), preferably about 15-30% (w/v), lead nitrate in alcohol (producing a white color on contact); or about 1-10% (w/v), preferably about 1-5% (w/v), copper sulfate in alcohol (producing a blue color on contact).

Alternatively, the first substance can be about 0.01M potassium permanganate and the second substance can be about 1.0 M sulfuric acid (original purple color changes to pink or colorless on contact); about 1.0 M sodium hydroxide (original purple changes to green on contact); or 0.01 M of sodium sulfite (original purple goes to brown on contact).

The first substance can be a methylene blue indicator and the second substance can be an acid, resulting in a blue color upon contact. Moreover, the first substance can be iodine and the second substance can be starch (producing a bluish blackish color on contact). In another embodiment, the first substance can be universal indicator solution and the second substance either an acid or a base, resulting in purple at pH 9, blue at pH 8, green at pH 7, and yellow at pH 4. Alternatively, the first substance can be anthocyanin, and the second can be an acid (producing a red color on contact) or a base (producing a yellow color on contact).

In other embodiments, the first substance can be vinegar or an aqueous solution of about 5-20% (w/v) aluminum sulfate and laundry detergent (6:1), and the second substance can be sodium hydrogen carbonate (producing a foam).

These and other examples of first and second substances can be found in “Chemical Magic” by Leonard A. Ford and revised by E. Winston Grundmeier (2nd edition 1993) and Hands-On Chemistry Activities with Real-Life Applications by Norman Herr and James Cunningham (1999), which are incorporated here by reference in their entirety.

The first and second substances can be applied to the film 1 in various ways. In some embodiments, the substance can be applied to the film 1 with a binder. Some appropriate binders include, but are not limited to, one or more of nitrocellulose, acrylic, PVB, vinyl, polyamide, polyurethane, and polyester binders. For example, when the substance is a solid, such as a powder or crystals, the substance can be applied to the film 1 by including the substance in the binder. In certain embodiments, such as when the substance is a liquid or gel, the substance can first be encapsulated and can then be applied to the film 1 with a binder. In some embodiments, the substance can be incorporated directly onto the film 1. This can be done, for example, by embedding a powder in a portion of the film 1, such as portions 17 and 19, when the film 1 is warm and supple, and then allowing the film 1 to cool, fixing the substance in place. Alternatively, the substance can be incorporated directly onto the film 1 as it is being applied to a load, such as load 2, so that the substance is held between successive layers of the stretch wrap, such as layers 7 and 9. For example, the substance can be applied by spraying or printing it on the film 1. In some embodiments, the spraying or printing of the substance could be synchronized with the wrapping process. For example, one substance can be applied as the wrap is angled inward and the second substance can be applied as the wrap is angled downward during the wrapping process.

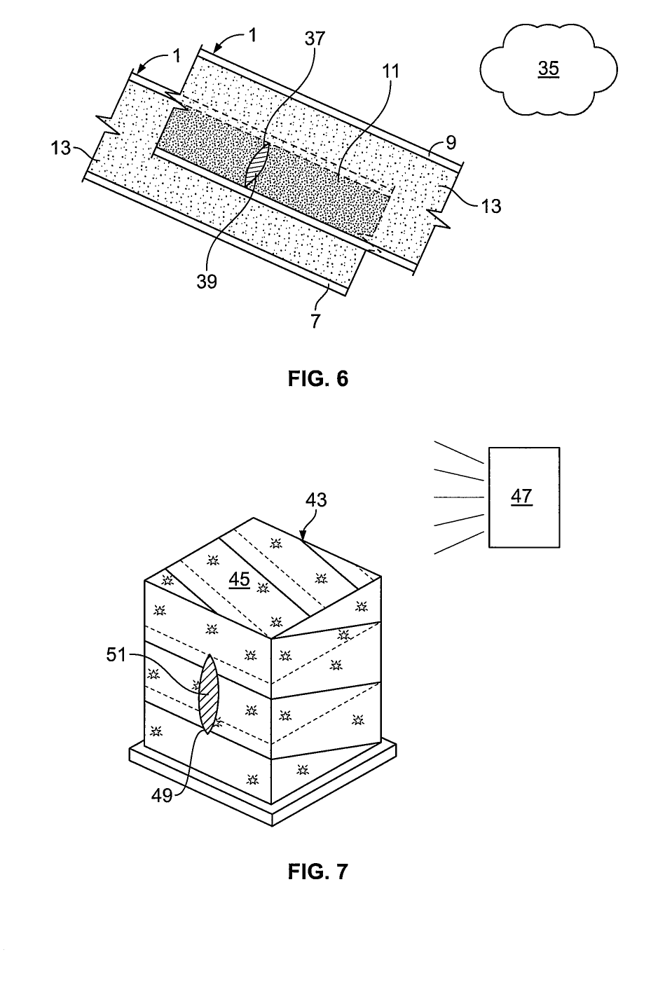

FIG. 6 shows an alternative embodiment where the second substance 35 is available in the vicinity of film 1, such as a gaseous material found in the ambient air about the film 1. In this embodiment, the film 1 has a coating 13 containing the first substance. When the film 1 is used as a stretch wrap, the coating 13 is located between the inner portion 7 and the outer portion 9. The coating 13 is normally isolated from the second substance 35, such as ambient air, by the outer portion 9. When there is a breach 37 of film 1, however, the coating 13 containing the first substance is exposed to the second substance 35 in the vicinity of film 1, and an observable change 39, such as a discoloration, occurs. Some examples of a second substance 35 in the vicinity of film 1 are oxygen, NOₓ (one or more of NO, NO₂, N₂O, N₂O₃, N₂O₄, etc.), moisture, or a fuel combustion product. In one application, the first substance can be an antioxidant, such as octadecyl-3,5-di-tert-butyl-4-hydroxyhydrocinnamate or butylated hydroxytoluene, and the second substance can be a fuel combustion product, such as such as carbon dioxide, NOₓ, or others produced by a forklift, that is readily available in a warehouse environment.

FIG. 7 shows an alternative embodiment where a stretch wrap 43 has a fluorescent signature 45 (shown here as a pattern though it could also be a solid color) when the stretch wrap 43 is exposed to an ultraviolet light or other electromagnetic energy 47. The fluorescent signature 45 is the appearance of the stretch wrap 43 as a whole when the stretchwrap 43 is exposed to the ultraviolet light 47. When the stretch wrap 43 is not exposed to the ultraviolet light 47, the signature 45 optionally can be arranged so it is not visible to an individual desiring to breach or tamper with the contents of the stretch wrap 43. Whenever desired, the stretch wrap 43 can be exposed to the ultraviolet light 47 to check for a breach 49. A change 51 in the fluorescent signature 45 of the stretch wrap 43, such as a disruption of a fluorescent pattern, would indicate that a breach 49 has occurred. This embodiment can especially detect the type of tampering where the original stretch wrap with the signature 45 has been wholly or partially removed and replaced with a wrap having a different fluorescent signature. For example, the fluorescent signature 45 will change even if the breach 49 is covered with a patch of material that changes the resulting fluorescent signature 45. Other arrangements and breaches are also contemplated.

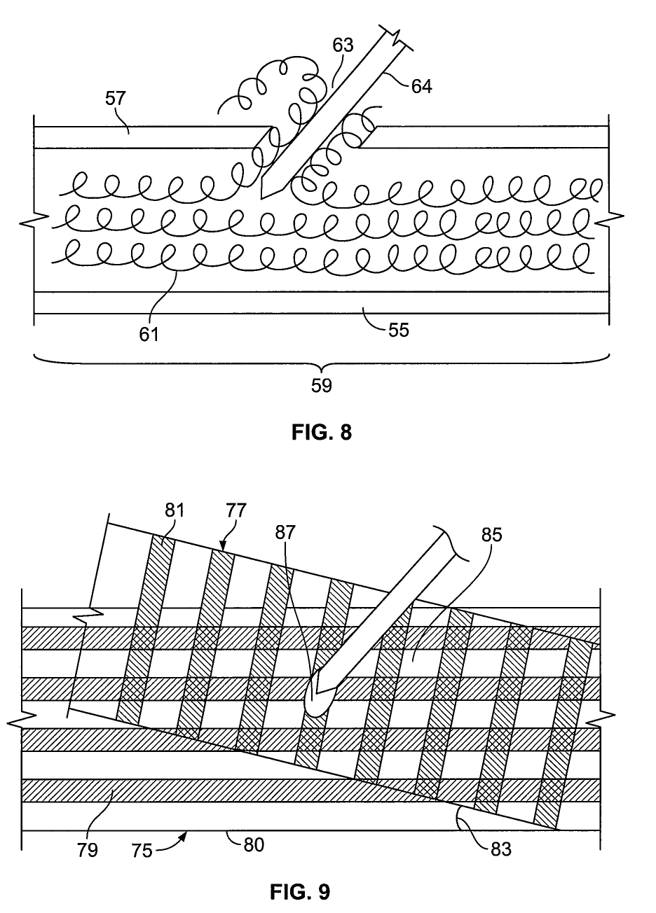

FIG. 8 shows an another embodiment of a cross section view of stretch wrap that includes an inner portion 55 and an outer portion 57 of film, where the outer portion 57 has an area of overlap 59 with the inner portion 55. Portions 55 and 57 can be successive wraps of one continuous sheet of film or layers of separate films. A substance 61, such as ink, is trapped between portions 55 and 57. When a breach 63 , such as a puncture or a tear, occurs to the outer portion 57, the substance 61 can escape from between portions 55 and 57, indicating that a breach 63 (as illustrated, due to a sharp object, such as a nail 64 used to puncture or cut the second layer 57) to the stretch wrap has occurred. The substance 61 can be any substance that will produce an observable indication that the outer portion 57 has been breached. One example of an appropriate substance is an ink that will cause a noticeable mess when the ink escapes from between the portions 55 and 57. In some embodiments, the substance can be an odorous liquid, gel, or gas.

FIG. 9 shows a detail view of an embodiment having a first layer 75 and a second layer 77. Layers 75 and 77 can be successive wraps of one continuous sheet of film or layers of separate films. The first layer 75 has a first pattern 79, such as lines that run horizontal to the edge 80 of the film. The second layer 77 has a second pattern 81, such as lines that run perpendicular to the edge 80 of the film. The second layer 77 is elongated and is positioned at an angle 83 relative to the first layer 75 so that the layers at least partially overlap. The overlap of the layers forms a third pattern 85. A breach 87 of the stretch wrap formed by layers 75 and 77 is indicated by a change in the third pattern 85.

The patterns 79 and 81 can be any patterns, which when layered at a predetermined elongation and at a predetermined position, form a predetermined third pattern 85. The patterns 79 and 81 include the design and color of the printing on the film. For example, the first pattern 79, as illustrated, can be lines that run horizontal, and the second pattern 81, as illustrated, can be lines that run perpendicular. In this example, the overlap of layers 79 and 81 can form a third pattern 85 of crisscrossing lines, as illustrated. In another example, the first pattern 79 can be a design of dots where the dots are yellow, and the second pattern 81 can be a design of dots where the dots are red. In this example, when the second layer 7 is elongated and is positioned at a predetermined position relative to the first layer 7, the dots can overlap and form a third pattern of orange dots.

Still referring to FIG. 9, angle 83 is the angle formed between the first layer 75 and the second layer 77. In embodiments where the layers 75 and 77 are formed by film being wound around a load, the angle 83 is the winding angle. The angle 83 can be any angle from 0 to 90 degrees, but is alternatively an angle between about 15 and 30 degrees. The angle 83 can also be varied as wrapping progresses, as can the patterns 79 and 81 applied.

In addition, the second layer 77 can be stretched at a predetermined elongation over the first layer 75. This predetermined elongation can be about 0 to about 400%. Alternatively, the predetermined elongation can be about 50 to about 350%. The predetermined elongation can also be varied as wrapping progresses.

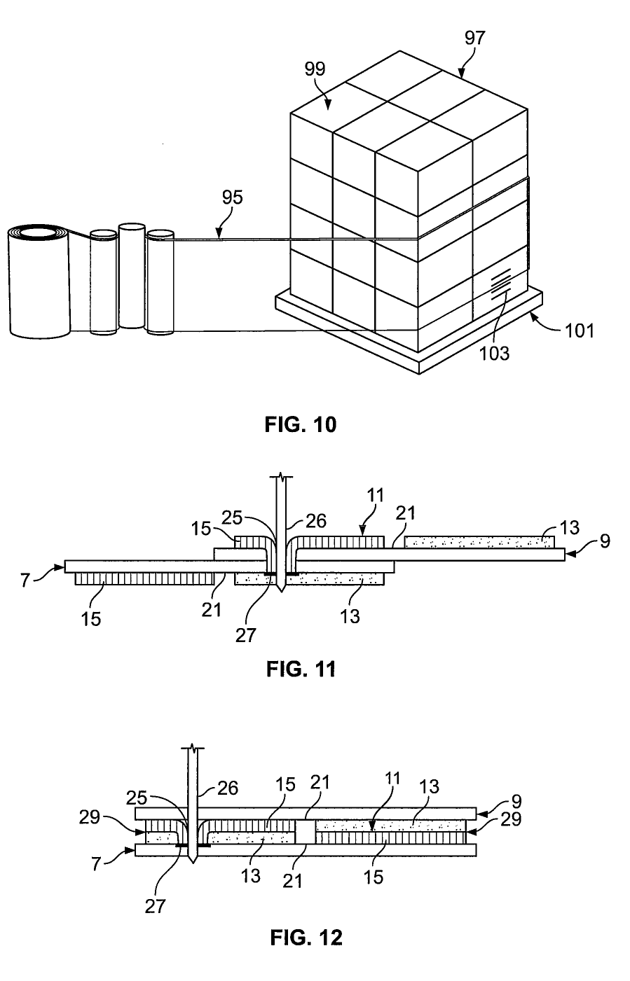

FIG. 10 shows a film 95 being wrapped around a load 97 of articles such as 99 stacked on a pallet 101 according to another embodiment. The film 95 is adapted to form tears, such as 103, in the machine direction when the film 95 is breached. The film 95 can be adapted to form tears, such as 103, by, for example, sufficiently elongating the film 95 in the machine direction so that when the film 95 is breached, such as by a puncture, tears (or splits) in the machine direction automatically form near and around the puncture site and make the breach evident. In other embodiments, the film 95 can be adapted to form tears (or splits) by laser scoring the film 95 in the machine direction, or by extruding the film 95 with fibrous additives in the machine direction. A breach of the film 95 can be detected by directly observing the tears 103 formed by the breach or through another expedient, such as ink confined between the layers of stretch wrap that escapes through the tears 103. In certain embodiments, the tears (or splits) tend to follow the machine direction of the film and do not cause the film to rupture across its width. In certain embodiments, the tears may separate the film into areas of strands, but it is believed that these strands would remain intact along their machine direction and this would serve to keep the articles such as 99 secured on the pallet 101 even when the film 95 is breached.

While the present technology has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiments disclosed, but that the invention will include all embodiments falling within the scope of the appended claims. Further, at least some of the numerical ranges stated above are not necessarily critical.

1. A tamper evident film comprising a single sheet of film having a first external coating containing a first substance and a second external coating containing a second substance whereby an observable change will occur when the second substance comes into contact with the first substance.

2. The tamper evident film of claim 1 where the observable change is a visible change.

3. The tamper evident film of claim 1 where the observable change is an olfactory change.

4. The tamper evident film of claim 1 where the first external coating is substantially on one portion of the film and the second external coating is substantially on another portion of the film.

5. A tamper evident film comprising a film having a coating containing a first substance whereby an observable change will occur when the first substance is exposed to at least one second substance present in the vicinity of the film.

6. The tamper evident film of claim 5 where the first substance is an antioxidant and the second substance includes at least one fuel combustion product.

7. The tamper evident film of claim 5 where the first substance is octadecyl-3,5-di-tert-butyl-4-hydroxyhydrocinnamate.

8. The tamper evident film of claim 5 where the first substance is butylated hydroxytoluene.

9. The tamper evident film of claim 5 where the second substance is at least one of oxygen, NOₓ, or moisture.

10. A tamper evident wrap comprising:
(a) an inner film portion having a first external coating containing a first substance, the inner film portion wrapped about a load; and
(b) an outer film portion having a second external coating containing a second substance, the outer film portion wrapped about and at least partially overlapping the inner film portion, whereby an observable change will occur when the first substance comes into contact with the second substance.

11. The tamper evident wrap of claim 10 whereby the coating on the inner film portion and the coating on the outer film portion face in the same direction.

12. The tamper evident wrap of claim 10 whereby the coating on the inner film portion and the coating on the outer film portion face toward each other.

13. The tamper evident wrap of claim 10 whereby the coating on the inner film portion and the coating on the outer film portion face in opposite directions from each other.

14. The tamper evident wrap of claim 10 whereby the coating on the inner film portion and the coating on the outer film portion are separated by at least one layer of film.

15. A method of detecting tampering with a wrap comprising:
(a) providing a wrap having a fluorescent signature when exposed to ultraviolet light;
(b) exposing the wrap to ultraviolet light;
(c) checking for a change in the fluorescent signature to determine whether the wrap has been breached.

16. A tamper evident wrap comprising:
(a) an inner film portion wrapped about a load, the inner film portion having a surface facing away from the load;
(b) an outer film portion wrapped about and at least partially overlapping with the inner film portion, the outer film portion having a surface facing toward the inner film portion; and
(c) a substance coated on at least one of the inner film portion surface and the outer film portion surface, located between the inner film portion and the outer film portion, and adapted to escape from between the portions when the outer film portion has been breached.

17. The tamper evident wrap of claim 16 whereby the substance is ink.

18. The tamper evident wrap of claim 16 whereby the substance is an odorous substance.

19. The tamper evident wrap of claim 16 whereby an observable change will occur when the substance comes into contact with a second substance.

20. A tamper evident wrap comprising:
(a) a first layer of film having a first pattern,
(b) a second layer of film having a second pattern, where the second layer at least partially overlaps the first layer so that the first pattern and the second pattern form a predetermined third pattern when the second layer is laid at a predetermined elongation and at a predetermined position relative to the first layer.

21. The tamper evident wrap of claim 20, where the predetermined elongation is at least 100%.

22. The tamper evident wrap of claim 20, where the second layer is at an angle of 0 to about 45 degrees relative to the first layer.

23. The tamper evident wrap of claim 20 where the first pattern has elements of one color and the second pattern has elements of a second color, whereby the predetermined third pattern is formed by the overlap of the first and the second colors.

24. A method of forming a tamper evident wrap comprising:
(a) laying a first layer of film having a first pattern over an article;
(b) laying, at a predetermined elongation and at a predetermined position relative to the first layer, a second layer of film having a second pattern over the first layer so that the first pattern and the second pattern form a predetermined third pattern.

25. A method of detecting tampering with a wrap comprising:
(a) providing a wrap having
(i) a first layer of film having a first pattern and a first predetermined elongation; and
(ii) a second layer of film, having a second pattern and a second predetermined elongation, whereby the second layer is positioned at a predetermined angle relative to the first layer and whereby the first layer and the second layer at least partially overlap so that the first pattern and the second pattern form a predetermined third pattern; and
(b) checking the wrap for a change in the predetermined third pattern to determine whether the wrap has been breached.

26. A tamper evident film adapted to form tears in the machine direction when the film is breached.
